(19) United States
(12) Patent Application Publication
(10) Pub. No.: US 2024/0372929 A1
(43) Pub. Date: Nov. 7, 2024

(54) APPLICATION PROXY-BASED SECURITY FOR RDP-TYPE COMMUNICATIONS SESSIONS

(71) Applicant: BUBBLE WORKSPACE LTD, AZOR (IL)

(72) Inventors: Nir CHERNOV, AZOR (IL); Maor DADUSH, GIVATAYIM (IL)

(21) Appl. No.: 18/772,175

(22) Filed: Jul. 14, 2024

Related U.S. Application Data
(63) Continuation-in-part of application No. PCT/IB2023/050696, filed on Jan. 26, 2023.
(60) Provisional application No. 63/303,561, filed on Jan. 27, 2022.
(60) Provisional application No. 63/303,568, filed on Jan. 27, 2022.
(60) Provisional application No. 63/303,575, filed on Jan. 27, 2022.

(51) Int. Cl. H04L 67/564; G06F 9/54; G06F 21/54; G06F 21/60

(52) U.S. Cl. CPC H04L 67/564; G06F 9/543; G06F 21/54; G06F 21/606

(57) ABSTRACT

A data security method of receiving, at a proxy, target data transmitted between first and second computers via the proxy and a computer network, the target data received during a communications session associated with a computer user and conducted in accordance with a protocol in which computer input device action data are transmitted by the first computer, via the proxy and the network, to the second computer and rendered as computer input device actions at the second computer, the action data describing keyboard keystroke actions and/or pointing device actions, including actions timing information, the actions corresponding to physical actions performed by the user using a keyboard connected to the first computer while interacting with the second computer via the network, creating a modified version of the target data in accordance with a predefined modification action, and transmitting the modified target data to either of the computers via the network.

### FIELD

The invention relates generally to computer security.

### BACKGROUND

Businesses that allow their employees to connect to company networks from remote locations face various security-related and management-related challenges. One such challenge involves not only ensuring that individuals who remotely access company networks and use company applications provide proper credentials and are authorized for such access and use, but also ensuring that such individuals are indeed who they say they are. Another challenge is monitoring the productivity of remote employees. A further challenge is ensuring the security of data that are accessed beyond company walls.

### SUMMARY

In one aspect of the invention a method is provided for authenticating computer users, the method including receiving, at a proxy, computer input device action data describing computer input device actions including any of keyboard keystroke actions and pointing device actions, and including timing information related to any of the actions, where the computer input device actions correspond to physical computer input device actions performed by a current computer user, using any of keyboard and a pointing device connected to a first computer, while interacting with a second computer via a computer network during a communications session associated with an identified computer user and conducted in accordance with a protocol in which the computer input device action data are transmitted by the first computer to the second computer via the proxy and rendered as the computer input device actions at the second computer, determining, during the communications session, whether the current computer user is the identified computer user, based on the result of a comparison of the computer input device action data received at the proxy with biometric data associated with the identified computer user, and performing, during the communications session, a predefined security action if the current computer user is determined to be other than the identified computer user.

In another aspect of the invention the predefined security action includes providing a notification to a system administrator.

In another aspect of the invention the predefined security action includes withholding any of the computer input device action data from being forwarded to the second computer.

In another aspect of the invention the predefined security action includes terminating the communications session.

In another aspect of the invention the predefined security action includes requiring the current computer user to submit or resubmit identification credentials or other identification information.

In another aspect of the invention the determining is performed at multiple times during the communications session.

In another aspect of the invention the multiple times are determined at any of random times, random time intervals, predefined times, predefined time intervals, when a predefined amount of new computer input device action data are received, and when a predefined amount and type of new computer input device action data are received.

In another aspect of the invention a is provided system for authenticating computer users, the system including a proxy configured to receive computer input device action data describing computer input device actions including any of keyboard keystroke actions and pointing device actions, and including timing information related to any of the actions, where the computer input device actions correspond to physical computer input device actions performed by a current computer user, using any of keyboard and a pointing device connected to a first computer, while interacting with a second computer via a computer network during a communications session associated with an identified computer user and conducted in accordance with a protocol in which the computer input device action data are transmitted by the first computer to the second computer via the proxy and rendered as the computer input device actions at the second computer, a user authenticator configured to determine, during the communications session, whether the current computer user is the identified computer user, based on the result of a comparison of the computer input device action data received at the proxy with biometric data associated with the identified computer user, and a security agent configured to perform, during the communications session, a predefined security action if the current computer user is determined to be other than the identified computer user.

In another aspect of the invention a method is provided for user productivity monitoring, the method including receiving, at a proxy, computer input device action data describing computer input device actions including any of keyboard keystroke actions and pointing device actions, and including timing information related to any of the actions, where the computer input device actions correspond to physical computer input device actions performed by a computer user, using any of keyboard and a pointing device connected to a first computer, while interacting with a second computer via a computer network during a communications session associated with the computer user and conducted in accordance with a protocol in which the computer input device action data are transmitted by the first computer to the second computer via the proxy and rendered as the computer input device actions at the second computer, and recording the timing information in a data store.

In another aspect of the invention the method further includes recording the timing information in association with an identifier associated with the computer user.

In another aspect of the invention the method further includes recording the timing information in association with an identifier associated with the communications session.

In another aspect of the invention a system is provided for user productivity monitoring, the system including a proxy configured to receive computer input device action data describing computer input device actions including any of keyboard keystroke actions and pointing device actions, and including timing information related to any of the actions, where the computer input device actions correspond to physical computer input device actions performed by a computer user, using any of keyboard and a pointing device connected to a first computer, while interacting with a second computer via a computer network during a communications session associated with the computer user and conducted in accordance with a protocol in which the computer input device action data are transmitted by the first computer to the second computer via the proxy and rendered as the computer input device actions at the second computer, and a productivity data manager configured to record the timing information in a data store.

In another aspect of the invention a method is provided for monitoring computer user inputs, the method including receiving, at a proxy, computer input device action data describing computer input device actions including keyboard keystroke actions, where the computer input device actions correspond to physical computer input device actions performed by a computer user, using a keyboard connected to a first computer, while interacting with a second computer via a computer network during a communications session associated with the computer user and conducted in accordance with a protocol in which the computer input device action data are transmitted by the first computer to the second computer via the proxy and rendered as the computer input device actions at the second computer, determining, if a delimited text string derived from the computer input device action data is found in a table of predefined text strings, and if the derived text string is associated with the computer user, and performing, during the communications session, a predefined security action if the derived text string is not associated with the computer user.

In another aspect of the invention the method further includes deriving the delimited text string from the computer input device action data.

In another aspect of the invention a system is provided for monitoring computer user inputs, the method including a proxy configured to receive computer input device action data describing computer input device actions including keyboard keystroke actions, where the computer input device actions correspond to physical computer input device actions performed by a computer user, using a keyboard connected to a first computer, while interacting with a second computer via a computer network during a communications session associated with the computer user and conducted in accordance with a protocol in which the computer input device action data are transmitted by the first computer to the second computer via the proxy and rendered as the computer input device actions at the second computer, a text string monitor configured to determine if a delimited text string derived from the computer input device action data is found in a table of predefined text strings, and if the derived text string is associated with the computer user, and a security agent configured to perform, during the communications session, a predefined security action if the derived text string is not associated with the computer user.

In another aspect of the invention a data security method is provided including receiving, at a proxy, target data transmitted between a first computer and a second computer via the proxy and a computer network, where the target data are received during a communications session associated with a computer user and conducted in accordance with a protocol in which computer input device action data are transmitted by the first computer, via the proxy and the computer network, to the second computer and rendered as computer input device actions at the second computer, where the computer input device action data describe the computer input device actions including any of keyboard keystroke actions and pointing device actions, and include timing information related to any of the actions, and where the computer input device actions correspond to physical computer input device actions performed by the computer user, using a keyboard connected to the first computer, while interacting with the second computer via the computer network during the communications session, creating a modified version of the target data in accordance with a predefined modification action, and transmitting the modified version of the target data to either of the computers via the computer network.

In another aspect of the invention the target data are received as clipboard-based data.

In another aspect of the invention the creating includes modifying the target data in accordance with a predefined data loss prevention action.

In another aspect of the invention the creating includes omitting a portion of the target data from the modified version of the target data.

In another aspect of the invention the target data is a data file having a first data file format, and where the creating includes converting the target data to a data file having a second data file format.

In another aspect of the invention the target data is a data file of a file type to which a predefined Content Disarm & Reconstruction technique may be applied, and where the creating includes deconstructing the target data file and reconstituting the target data file as the modified version of the target data in which all elements of the target data file that do not match standards and policies that are predefined for the file type's are omitted from the reconstituted data file.

In another aspect of the invention a data security system is provided including a proxy configured to receive target data transmitted between a first computer and a second computer via the proxy and a computer network, where the target data are received during a communications session associated with a computer user and conducted in accordance with a protocol in which computer input device action data are transmitted by the first computer, via the proxy and the computer network, to the second computer and rendered as computer input device actions at the second computer, where the computer input device action data describe the computer input device actions including any of keyboard keystroke actions and pointing device actions, and include timing information related to any of the actions, and where the computer input device actions correspond to physical computer input device actions performed by the computer user, using a keyboard connected to the first computer, while interacting with the second computer via the computer network during the communications session, and a data security manager configured to create a modified version of the target data in accordance with a predefined modification action, where the proxy is additionally configured to transmit the modified version of the target data to either of the computers via the computer network.

### BRIEF DESCRIPTION OF THE DRAWINGS

Aspects of the invention will be understood and appreciated more fully from the following detailed description taken in conjunction with the appended drawings in which:

FIG. 1A is a simplified conceptual illustration of a system for system for authenticating computer users, constructed and operative in accordance with an embodiment of the invention;

FIG. 1B is a simplified flowchart diagram of an exemplary method of operation of the system of FIG. 1A, operative in accordance with an embodiment of the invention;

FIG. 2A is a simplified conceptual illustration of a system for system for monitoring user productivity, constructed and operative in accordance with an embodiment of the invention;

FIG. 2B is a simplified flowchart diagram of an exemplary method of operation of the system of FIG. 2A, operative in accordance with an embodiment of the invention;

FIG. 3A is a simplified conceptual illustration of a system for monitoring computer user inputs, constructed and operative in accordance with an embodiment of the invention;

FIG. 3B is a simplified flowchart diagram of an exemplary method of operation of the system of FIG. 3A, operative in accordance with an embodiment of the invention;

FIG. 3C is a table of administrative user name names that may be used by privileged users to access restricted software applications, which is useful in understanding the system of FIG. 3A and method of 3B;

FIG. 4A is a simplified conceptual illustration of a data security system, constructed and operative in accordance with an embodiment of the invention; and

FIG. 4B is a simplified flowchart diagram of an exemplary method of operation of the system of FIG. 4A, operative in accordance with an embodiment of the invention.

### DETAILED DESCRIPTION

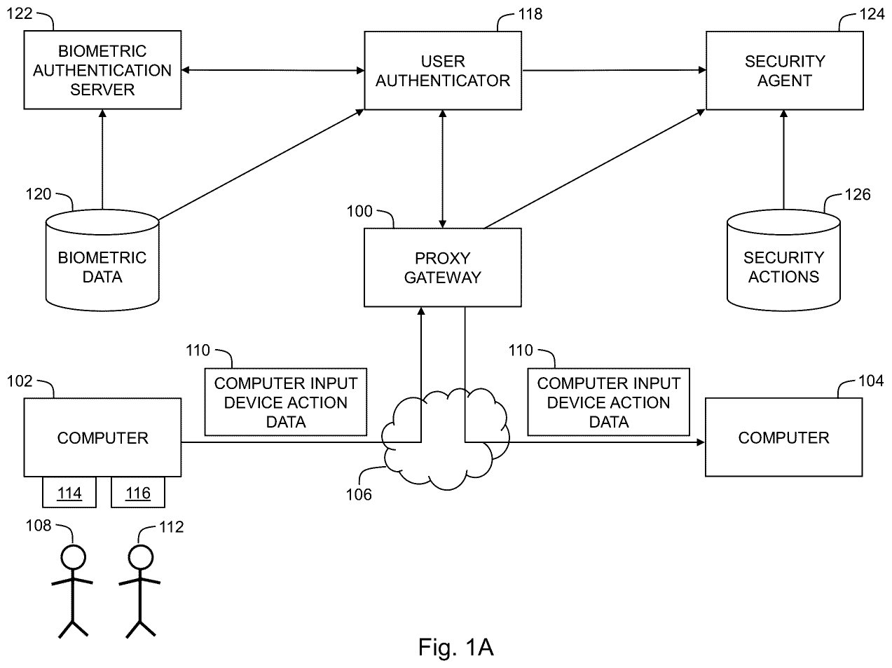

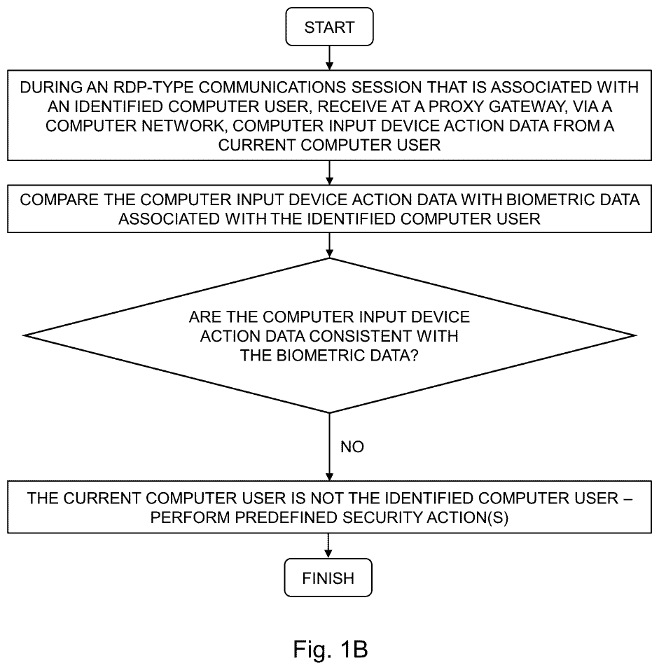

Reference is now made to FIG. 1A, which is a simplified conceptual illustration of a system for authenticating computer users, constructed and operative in accordance with an embodiment of the invention, and additionally to FIG. 1B, which is a simplified flowchart diagram of an exemplary method of operation of the system of FIG. 1A, operative in accordance with an embodiment of the invention. In the system of FIG. 1A and method of FIG. 1B, a proxy 100 is configured to facilitate a communications session between a computer 102 and a computer 104 via a computer network 106, such as the Internet, where:
the communications session is associated with an identified computer user 108 and is conducted in accordance with a protocol in which computer input device action data 110 are transmitted by computer 102, via computer network 106, to computer 104 via proxy 100 and rendered as computer input device actions at computer 104;
where computer input device action data 110 describe the computer input device actions including any of keyboard keystroke actions and pointing device actions, and include timing information related to any of the actions; and
where the computer input device actions correspond to physical computer input device actions, such as are performed by a current computer user 112, using any of a keyboard 114 and a pointing device 116 connected to computer 102, while interacting with computer 104 via computer network 106 during the communications session.

In one embodiment computer 102 communicates with proxy 100 via computer network 106. In another embodiment proxy 100 is hosted by computer 102, such as where proxy 100 is implemented in computer hardware installed within computer 102 and/or computer software that is executed by computer 102.

Computer 104 is preferably configured, in accordance with conventional techniques, to require communications from computer 102 during the communications session to be routed through, or otherwise pass through, proxy 100. Proxy 100 is configured with the ability to access any data that are transmitted between computer 102 and computer 104 via, or otherwise through, proxy 100 during the communications session that is conducted in accordance with the protocol. This includes any and all data that are transmitted in accordance with the protocol, such as, but not limited to, data describing keyboard keystroke actions and pointing device actions, timing information related to any of the actions, display contents, clipboard contents, and protocol-related messages such as error messages.

The communications session is conducted in accordance with any protocol that provides the functionality described above, such as, but not limited to, the Remote Desktop Protocol™ (RDP) developed by Microsoft Corporation of Redmond, Washington, USA; the HDX protocol developed by Citrix Systems, Inc. of Fort Lauderdale, Florida, USA; the PC-over-IP (PCoIP) protocol developed by Teradici Corporation and supported by VMware Horizon™ from VMware, Inc.; and the open-source Virtual Network Computing (VNC) protocol. Computer input device action data 110 includes any type of information supported by such protocols that are related to keyboard and pointing device use. The term “RDP-type protocol” is used herein to refer to any protocol that provides the functionality described above, and the term “RDP-type communications session” is used herein to refer to a communications session that is conducted in accordance with any such protocol.

A user authenticator 118 is configured to determine, during the communications session, whether current computer user 112 is identified computer user 108, based on the result of a comparison of computer input device action data 110 with biometric data 120 associated with identified computer user 108. In one embodiment, biometric data 120 are configured based on computer input device action data describing previous keyboard and pointing device use by identified computer user 108. Thereafter, when computer input device action data 110 associated with current computer user 112 are received in association with identified computer user 108, such as in a communications session that was initiated using a user name and password associated with identified computer user 108, computer input device action data 110 are evaluated in accordance with biometric authentication techniques that compare computer input device action data 110 with biometric data 120 associated with identified computer user 108 to determine, in accordance with predefined criteria, whether computer input device action data 110 are consistent with biometric data 120, and thus whether current computer user 112 is, in fact, identified computer user 108. Techniques for configuring biometric data 120 and performing such biometric authentication are described, for example, in “TypeNet: Deep Learning Keystroke Biometrics” by Acien, et al.

In one embodiment, user authenticator 118 is integrated into proxy 100. In another embodiment, user authenticator 118 is separate from proxy 100, and both the identity of identified computer user 108 and computer input device action data 110 are provided to user authenticator 118, such as via a computer network. In one embodiment, user authenticator 118 performs the comparison of computer input device action data 110 with biometric data 120 associated with identified computer user 108, where user authenticator 118 is configured with biometric data 120 associated with identified computer user 108. In another embodiment, the comparison is performed by a biometric authentication server 122, where user authenticator 118 provides the identity of identified computer user 108 and computer input device action data 110 to biometric authentication server 122, such as via a computer network, where biometric authentication server 122 is either configured with biometric data 120 associated with identified computer user 108 or is provided with this information as well.

In one embodiment, user authenticator 118 is configured to determine at different times during the communications session whether current computer user 112 is identified computer user 108 as described above, such as at random times or time intervals, at predefined times or time intervals, when a predefined amount, or amount and type, of new computer input device action data 110 are received (e.g., after every ten keyboard keystrokes are received), or any combination of these factors.

A security agent 124 is configured to perform, during the communications session, one or more predefined security actions 126 if current computer user 112 is determined to be other than identified computer user 108, such as, but not limited to, providing a notification to a system administrator, withholding any of computer input device action data 110 from being forwarded to computer 104, terminating the communications session, or requiring the computer user to submit or resubmit identification credentials or other identification information.

The system of FIG. 1A and method of FIG. 1B may be illustrated in the context of the following exemplary scenario in which a computer user at computer 102 initiates an RDP-type communications session with computer 104 via proxy 100 and provides a user name and password to computer 104 to access computer 104 itself. The user name and password are checked by computer 104 and are found by computer 104 to identify a particular computer user, who is now referred to as identified computer user 108. However, it is not known whether the computer user that provided the user name and password, who is now referred to as current computer user 112 is, in fact, identified computer user 108 or is an imposter. To address this, proxy 100, which receives keyboard keystroke actions and pointing device actions performed by current computer user 112 in the form of computer input device data 110 in accordance with the RDP protocol, and which received the user name as well, provides this information to user authenticator 118. User authenticator 118 provides the user name and computer input device data 110 to biometric authentication server 122 which then accesses biometric data 120 associated with identified computer user 108, compares computer input device data 110 to biometric data 120, and determines, in accordance with predefined criteria, that computer input device data 110 are not consistent with biometric data 120, and thus determines that current computer user 112 is not, in fact, identified computer user 108, but rather is an imposter. Biometric authentication server 122 provides this information to user authenticator 118, which then instructs security agent 124 to take appropriate security actions.

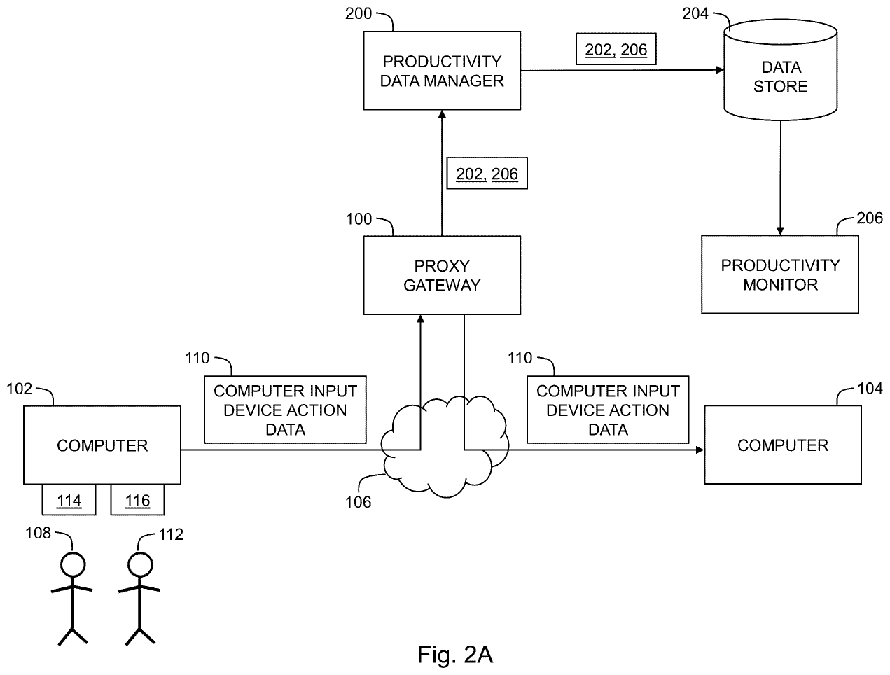

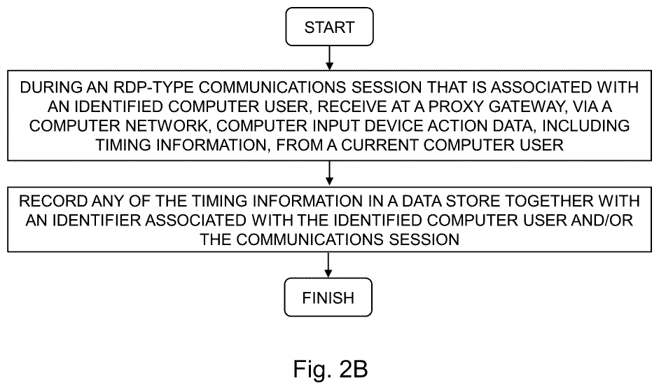

Reference is now made to FIG. 2A, which is a simplified conceptual illustration of a system for monitoring user productivity, constructed and operative in accordance with an embodiment of the invention, and additionally to FIG. 2B, which is a simplified flowchart diagram of an exemplary method of operation of the system of FIG. 2A, operative in accordance with an embodiment of the invention. The system of FIG. 2A includes one or more elements of the system of FIG. 1A that are similarly configured except as is otherwise now described. In the system of FIG. 2A and method of FIG. 2B, proxy 100 is configured as described hereinabove to facilitate an RDP-type communications session between computer 102 and computer 104 via computer network 106, where the communications session is associated with identified computer user 108. Proxy 100 receives computer input device action data 110 from computer 102, where computer input device action data 110 describe keyboard keystroke actions and/or pointing device actions, and include timing information related to any of the actions.

A productivity data manager 200 is configured to record timing information 202 in a data store 204, which may be any type of data storage device. Timing information 202 includes any of the timing information included in computer input device action data 110, where timing information 202 are preferably recorded after authenticating current computer user 112 as being identified computer user 108 as described hereinabove with reference to FIGS. 1A and 1B. Timing information 202 is preferably stored together with an identifier 206, such as an identifier associated with identified computer user 108 and/or with the communications session itself.

Timing information 202 preferably include any type of timing information that are used by conventional user productivity monitoring techniques, such as, but not limited to, timestamps indicating when keyboard keystroke actions and/or pointing device actions are performed. Timing information 202 may be queried, such as by a productivity monitor 208, in accordance with conventional user productivity monitoring techniques to provide productivity information associated with such techniques.

In one embodiment, productivity data manager 200 is integrated into proxy 100. In another embodiment, productivity data manager 200 is separate from proxy 100 and receives timing information 202 and identifier 206 from proxy 100.

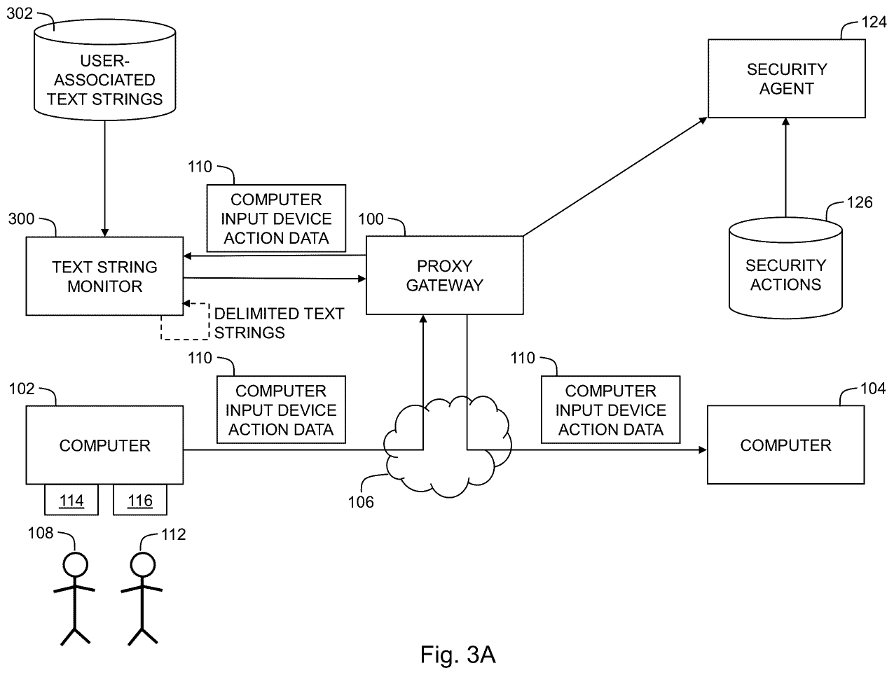

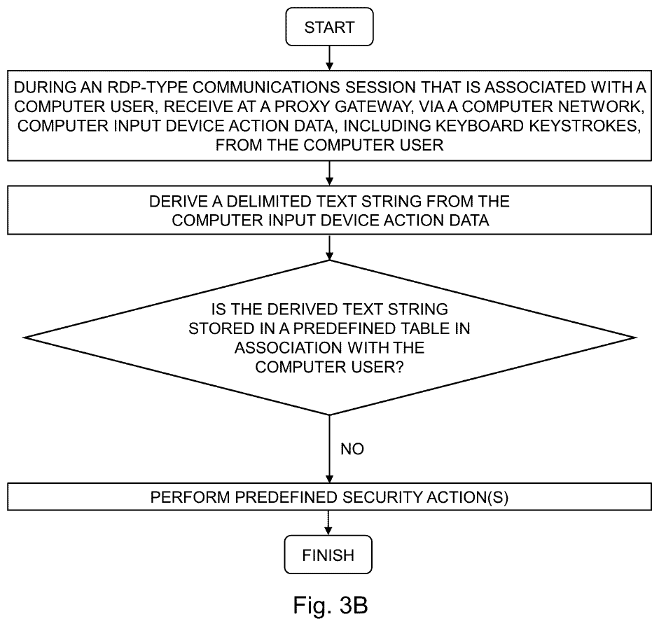

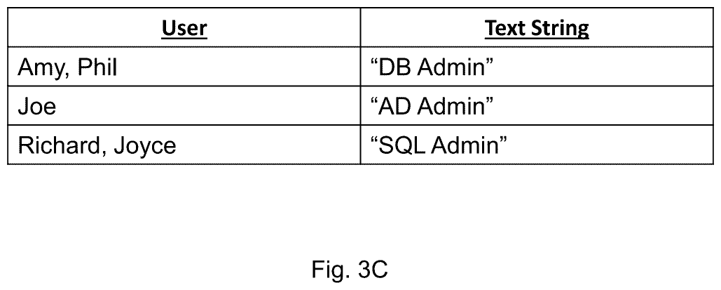

Reference is now made to FIG. 3A, which is a simplified conceptual illustration of a system for monitoring computer user inputs, constructed and operative in accordance with an embodiment of the invention, and additionally to FIG. 3B, which is a simplified flowchart diagram of an exemplary method of operation of the system of FIG. 3A, operative in accordance with an embodiment of the invention. The system of FIG. 3A includes one or more elements of the system of FIG. 1A that are similarly configured except as is otherwise now described. In the system of FIG. 3A and method of FIG. 3B, proxy 100 is configured as described hereinabove to facilitate an RDP-type communications session between computer 102 and computer 104 via computer network 106, where the communications session is associated with identified computer user 108. Proxy 100 receives computer input device action data 110 from computer 102, where computer input device action data 110 describe keyboard keystroke actions (although computer input device action data 110 may additionally describe pointing device actions and include timing information related to any of the actions).

A text string monitor 300 is configured to derive delimited text strings from the keyboard keystrokes described by computer input device action data 110, such as where the text strings are delimited by spaces, and determine if a derived text string is found in a table 302 of predefined text strings that are associated with specific user identities. If a derived text string is found in table 302, but it is not associated in table 302 with identified computer user 108, security agent 124 performs one or more predefined security actions 126.

In one embodiment, text string monitor 300 is integrated into proxy 100. In another embodiment, text string monitor 300 is separate from proxy 100 and receives computer input device action data 110 from proxy 100.

The system of FIG. 3A and method of FIG. 3B may be illustrated in the context of the following exemplary scenario in which current computer user 112 at computer 102 initiates an RDP-type communications session with computer 104 via proxy 100 and is authenticated as being identified computer user 108, whose user name is “Bob”, as described hereinabove with reference to FIGS. 1A and 1B. Text string monitor 300 derives the text string “AD admin” from computer input device action data 110 that proxy 100 receives from computer 102 during the RDP-type communications session. Text string monitor 300 checks table 302, the contents of which is shown in FIG. 3C, which is a table of administrative user name names that may be used by privileged users to access restricted software applications. Text string monitor 300 determines that while the derived text string “AD admin” is found in table 302, it is not associated in table 302 with “Bob”, but is instead associated with another user whose user name is “Joe”. Text string monitor 300 provides this information to proxy 100, which then instructs security agent 124 to take appropriate security actions.

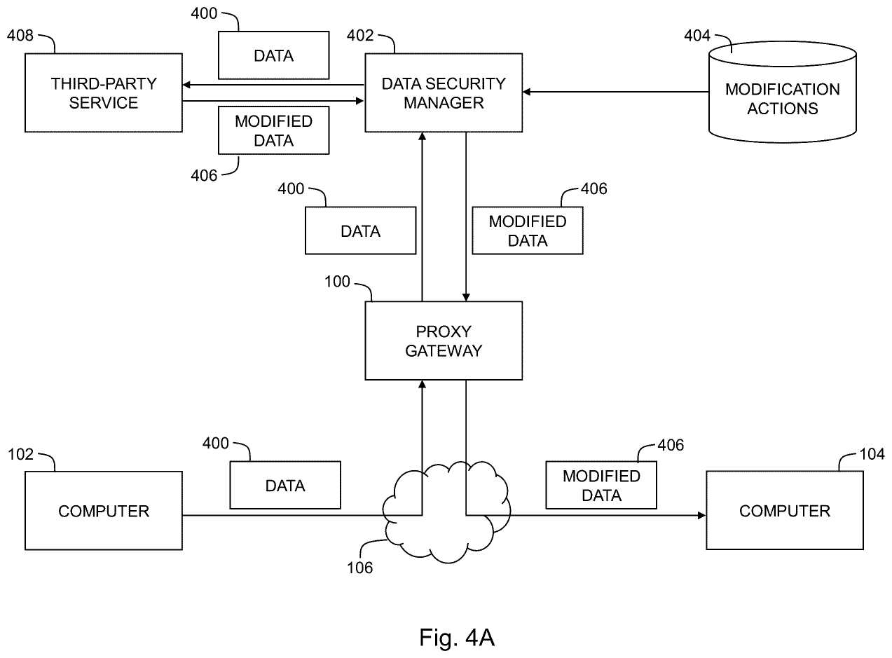

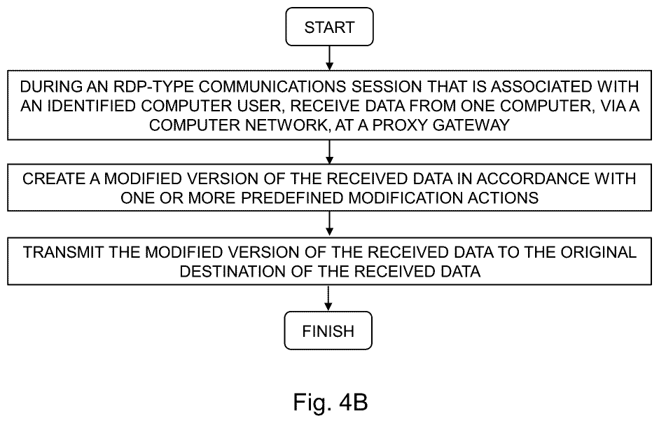

Reference is now made to FIG. 4A, which is a simplified conceptual illustration of a data security system, constructed and operative in accordance with an embodiment of the invention, and additionally to FIG. 4B, which is a simplified flowchart diagram of an exemplary method of operation of the system of FIG. 4A, operative in accordance with an embodiment of the invention. The system of FIG. 4A includes one or more elements of the system of FIG. 1A that are similarly configured except as is otherwise now described. In the system of FIG. 4A and method of FIG. 4B, proxy 100 is configured as described hereinabove to facilitate an RDP-type communications session between computer 102 and computer 104 via computer network 106, where the communications session is associated with identified computer user 108. Aside from computer input device action data 110 (FIG. 1A) that proxy 100 may receive as described hereinabove, proxy 100 receives data 400 from computer 102 or from computer 104 (although for the sake of brevity, FIG. 4A shows the flow of data 400 in one direction only). Data 400 includes any type of data such as, but not limited to, text, images, or data files that are copied to a clipboard application that is provided by the operating system of either computer. Data 400 may include any and all data that are transmitted in accordance with the RDP-type protocol of the communications session.

A data security manager 402 is configured to create a modified version of data 400 in accordance with one or more predefined modification actions 404, where the modified version of data 400 is now referred to as modified data 406. In one embodiment, modified data 406 is created by modifying data 400 in accordance with one or more predefined data loss prevention actions, such as in accordance with any technique for masking, obscuring, or omitting personally identifiable information (PII) included in data 400. For example, where a computer user copies a credit card number to the clipboard, data security manager 102 may replace the credit card number with xxxx-xxxx-xxxx-xxxx. In another embodiment, where data 400 is a data file of a given type to which Content Disarm & Reconstruction (CDR) techniques may be applied, such as to Microsoft Word™ files, data security manager 102 may apply CDR techniques to the data file by deconstructing the data 400 data file and reconstituting the data file as modified data 406 in which all elements of the data 400 data file that do not match standards and policies that are predefined for the file type's are omitted from the modified data 406 data file. In another embodiment, where data 400 is a data file in a given data file format, such as the .XLSX format of Microsoft Excel™ data files, modified data 406 is created by converting data 400 to a different data file format, such as the .PDF format of Adobe Acrobat™ data files, and optionally including a predefined watermark. Then, instead of transmitting data 400, proxy 100 transmits modified data 406 via computer network 106 to whichever of computers 102 or 104 is the original destination of data 400 (although for the sake of brevity, FIG. 4A shows the flow of modified data 406 in one direction only).

In one embodiment, data security manager 402 is integrated into proxy 100. In another embodiment, data security manager 402 is separate from proxy 100 and receives data 400 from proxy 100. In another embodiment, data security manager 402 provides data 400 to a third-party service 408 which creates modified data 406 as described hereinabove and provides modified data 406 to data security manager 402.

In conclusion, the invention, various embodiments of which have been described hereinabove, leverages the vantage point of a proxy through which computers communicate in an RDP-type communications session. The invention provides application-level intervention that allows connection and remote control from a remote workstation to a remote server. The application-level intervention is carried out by intercepting and manipulating in-protocol communications between the user client (e.g., RDP client) to the remote service (e.g., RDP server). The invention contemplates various possible architectures including:
1. Client proxy: A software layer that functions as an application proxy is added to the RDP client installed on the local computer enabling the application-level proxy to intercept and manipulate in-protocol communications;
2. Server proxy: Communication between the client and the remote server is done through a proxy that is aware of the protocol and can intercept and manipulate in-protocol communications. The proxy acts as a network bridge between the client and the server.

With regard to businesses that allow their employees to connect to company networks from remote locations, the invention, in various embodiments, relates to ensuring that individuals who remotely access company networks and use company applications in association with particular user identities are not only authorized for such access and use, but also are indeed who they say they are, and preferably do so the entire time that they use company's resources in this manner. The invention, in various embodiments, further relates to monitoring the productivity of remote employees and ensuring the security of data that are accessed remotely.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A data security method comprising:
receiving, at a proxy, target data transmitted between a first computer and a second computer via the proxy and a computer network,
where the target data are received during a communications session associated with a computer user and conducted in accordance with a protocol in which computer input device action data are transmitted by the first computer, via the proxy and the computer network, to the second computer and rendered as computer input device actions at the second computer,
where the computer input device action data describe the computer input device actions including any of keyboard keystroke actions and pointing device actions, and include timing information related to any of the actions, and
where the computer input device actions correspond to physical computer input device actions performed by the computer user, using a keyboard connected to the first computer, while interacting with the second computer via the computer network during the communications session;
creating a modified version of the target data in accordance with a predefined modification action; and
transmitting the modified version of the target data to either of the computers via the computer network.

2. The method according to claim 1 where the target data are received as clipboard-based data.

3. The method according to claim 1 wherein the creating comprises modifying the target data in accordance with a predefined data loss prevention action.

4. The method according to claim 1 wherein the creating comprises omitting a portion of the target data from the modified version of the target data.

5. The method according to claim 1 wherein the target data is a data file having a first data file format, and wherein the creating comprises converting the target data to a data file having a second data file format.

6. The method according to claim 1 wherein the target data is a data file of a file type to which a predefined Content Disarm & Reconstruction technique may be applied, and wherein the creating comprises deconstructing the target data file and reconstituting the target data file as the modified version of the target data in which all elements of the target data file that do not match standards and policies that are predefined for the file type's are omitted from the reconstituted data file.

7. A data security system comprising:
a proxy configured to receive target data transmitted between a first computer and a second computer via the proxy and a computer network,
where the target data are received during a communications session associated with a computer user and conducted in accordance with a protocol in which computer input device action data are transmitted by the first computer to the second computer via the proxy and the computer network and rendered as computer input device actions at the second computer,
where the computer input device action data describe the computer input device actions including any of keyboard keystroke actions and pointing device actions, and include timing information related to any of the actions, and
where the computer input device actions correspond to physical computer input device actions performed by the computer user, using a keyboard connected to the first computer, while interacting with the second computer via the computer network during the communications session; and
a data security manager configured to create a modified version of the target data in accordance with a predefined modification action,
wherein the proxy is additionally configured to transmit the modified version of the target data to either of the computers via the computer network.

8. The system according to claim 7 where the target data are received as clipboard-based data.

9. The system according to claim 7 wherein the data security manager is configured to modify the target data in accordance with a predefined data loss prevention action.

10. The system according to claim 7 wherein the data security manager is configured to omit a portion of the target data from the modified version of the target data.

11. The system according to claim 7 wherein the target data is a data file having a first data file format, and wherein the data security manager is configured to convert the target data to a data file having a second data file format.

12. The system according to claim 7 wherein the target data is a data file of a file type to which a predefined Content Disarm & Reconstruction technique may be applied, and wherein the data security manager is configured to deconstruct the target data file and reconstitute the target data file as the modified version of the target data in which all elements of the target data file that do not match standards and policies that are predefined for the file type's are omitted from the reconstituted data file.
